(19) United States
(12) Patent Application Publication
(10) Pub. No.: US 2019/0102831 A1
(43) Pub. Date: Apr. 4, 2019

(54) System and Method for Virtual Display of Customized Products in a Facility

(71) Applicant: Walmart Apollo, LLC, Bentonville, AR (US)

(72) Inventors: Behzad Nemati, Springdale, AR (US); Ehsan Nazarian, Rogers, AR (US)

(21) Appl. No.: 16/148,618

(22) Filed: Oct. 1, 2018

Related U.S. Application Data
(60) Provisional application No. 62/566,956, filed on Oct. 2, 2017.

(51) Int. Cl. G06Q 30/06; G06F 3/0488; G06F 3/0484; G06Q 30/02

(52) U.S. Cl. CPC G06Q 30/0643; G06F 3/04883; G06Q 30/0237; G06Q 30/0621; G06F 3/04845

(57) ABSTRACT

A virtual display system in a facility is discussed. An exemplary system includes a server, client device, interactive touchscreen, databases, and a product retrieval module. One or more large interactive touchscreens are used to simultaneously display images of multiple products at an actual size, allow their manipulation, accept customization input and update the images based on the requested customization. Dynamic pricing tied to the customization is also displayed.

### CROSS-REFERENCE TO RELATED PATENT APPLICATION

This application claims priority to U.S. Provisional Application 62/566,956 filed on Oct. 2, 2017, the content of which is hereby incorporated by reference in its entirety.

### BACKGROUND

Facilities such as retail stores frequently display products to the public. The facilities have to balance their inventory of items against the amount of available floor space. Large cumbersome products may not be suited to display due to space and assembly constraints.

### BRIEF DESCRIPTION OF DRAWINGS

Illustrative embodiments are shown by way of example in the accompanying drawings and should not be considered as a limitation of the present disclosure: In the drawings:

FIG. 1 is a block diagram illustrating a system for presenting products on virtual shelves in a retail space according to one exemplary embodiment.

FIG. 2 is a diagram illustrating a virtual display system in a retail space according to one exemplary embodiment.

FIG. 3 is a diagram illustrating a virtual display system in a retail space according to one exemplary embodiment.

FIG. 4 is a diagram illustrating a use of a virtual display system in a retail space according to an exemplary embodiment.

FIG. 5 is a diagram illustrating a use of a virtual display system in a retail space according to an exemplary embodiment.

FIG. 6 is a block diagram illustrating a process for presenting products using a virtual display system in a retail space according to an exemplary embodiment.

FIG. 7 is a block diagram illustrating an exemplary computing device suitable for use in an exemplary embodiment.

### DETAILED DESCRIPTION

Described in detail herein are systems and methods for virtually displaying customized products in a facility. The virtual display system may include large interactive touchscreens disposed in a facility that are coupled to servers to provide pricing, customization, and discounting information and to display actual size images of larger products.

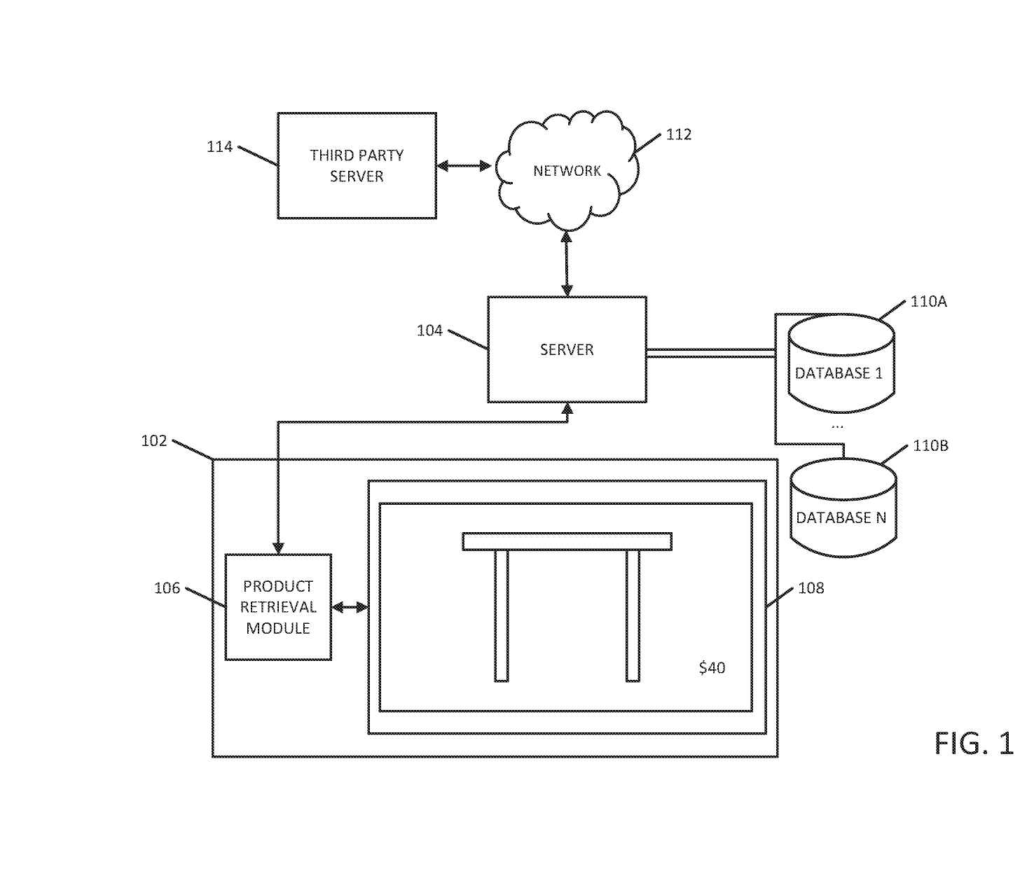

FIG. 1 is a block diagram illustrating a system for presenting products on virtual shelves in a retail space according to one exemplary embodiment. In the exemplary embodiment of FIG. 1, the system includes a client device 102. The client device 102 provides the point of entry for a user. The client device 102 may include a processor configured to execute a product retrieval module 106. The client device may also include, or communicate with, an interactive touchscreen 108. The product retrieval module 106 may be executed on the client device 102 as software. The product retrieval module 106 provides the logic to display images on, and receive input from, the interactive touchscreen 108. The product retrieval module 106 may be communicatively coupled with a server 104 via a communication interface (not shown). The product retrieval module 106 may utilize application programming interfaces (APIs) to interface with the server 108. The product retrieval module 106 may retrieve product information including images and pricing information from the server 104.

Continuing with the description of the exemplary embodiment of FIG. 1, the server 104 interfaces with the product retrieval module 106, databases 110A, 110B, and a network 112. The server 104 retrieves product information from the databases 110A, 110B. The server 104 provides the product information to the product retrieval module 106. The product information may include pricing, images, renderings, specifications, sizes, availability, color selections, materials, textual descriptions, and reviews. It should be appreciated that the databases 110A, 110B may also be accessed via network 112.

The interactive touchscreen 108 provides graphical display capabilities for the client device 102. The interactive touchscreen 108 may be based on capacitive, resistive, infrared or any technology suitable to register a touch or gesture-based input on a display, and translate the touch or gesture to an input. The interactive touchscreen 108 may be sized according to the retail space and the products to be displayed at their actual size. For example larger products, such as furniture may require an interactive touchscreen 108 with a diagonal measurement of 120 inches or greater. Smaller products may require an interactive touchscreen 108 with a diagonal measurement of 36 inches or greater. Medium sized products may require an interactive touchscreen with a diagonal measurement of 72 inches or greater. In another embodiment, multiple interactive touchscreens 108 may be used to facilitate product comparison for larger products displayed at actual size.

The databases 110A, 110B may contain relevant product information for display on the client device 102. The databases 110A, 110B may be implemented in off-the-shelf database stacks or custom built databases. The databases 110A, 110B may include, but are not limited to, product descriptions, product images, current product pricing information, historical product pricing information, inventory status for the product, store or warehouse location of the product, customization options, available delivery methods, and user reviews. The databases 110A, 110B are accessible by the server and may cohabitate the same physical computer system. Alternatively, they may be logically connected yet physically separate.

The network 112 facilitates inbound and outbound communications from the server 104. In one embodiment, the network 112 may be the Internet. In another embodiment, the network 112 may be a virtual private network (VPN) or some other type of network. The network 112 provides a communication channel between the server 104 and a third party server 114. The third party server 114 may provide the server 104 with information relating to customization options. For example, when the server 104 presents customization options to the client device 102, the server may receive available customization options from the third party server 114, where the third party server contains information about the product controlled by the manufacturer of the product. It will be appreciated that in other embodiments, the customization information may have previously been downloaded to server 104 and/or stored in databases 110A, 110B.

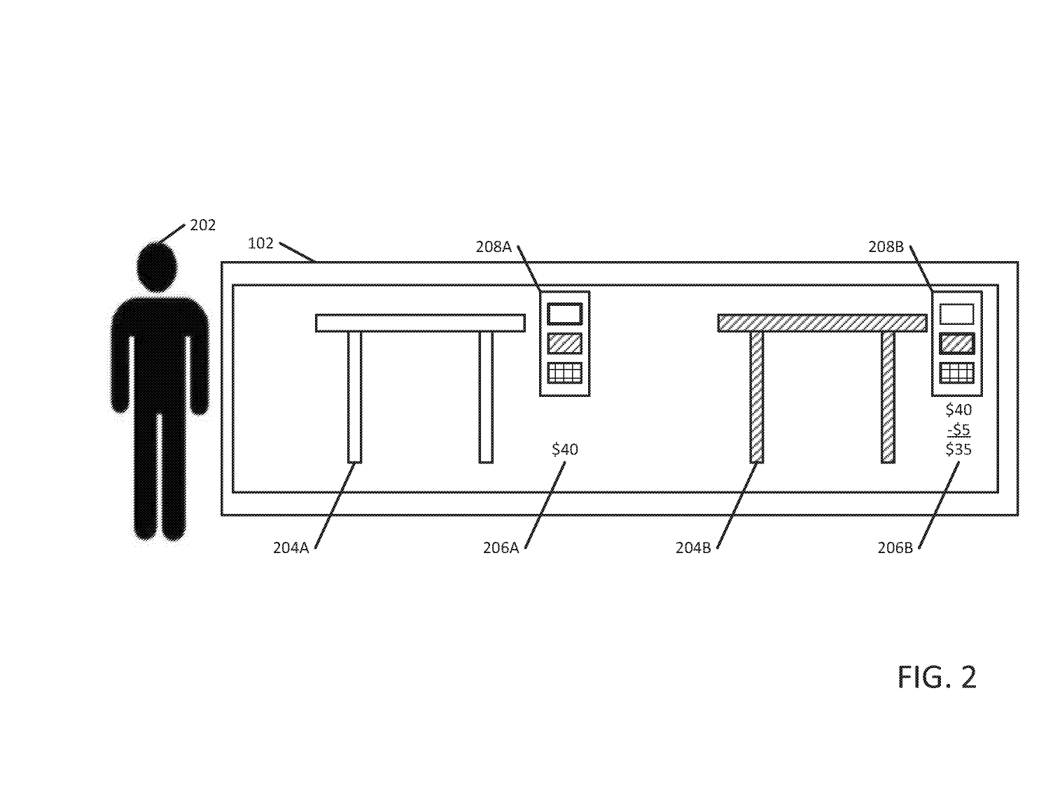

FIG. 2 is a diagram illustrating a virtual display system in a retail space according to an exemplary embodiment. The virtual display system includes a client device 102. The client device 102 presents to a user 202, customizing options 208A, 208B, and two customized products 204A, 204B. The customized products 204A, 204B are displayed simultaneously in their actual size on the touchscreen with the respective selected customizing options 208A, 208B applied to the images of the customized products 204A, and 204B. For each of the customized products 204A, 204B, pricing information 206A, 206B may be displayed. Based on the customizing options 208A, 208B selected, the pricing information 206A, 206B may display discounting. The discount may be a factor of customization items selected including materials and colors. For example, if a selected material dictates a lower market price, the discounting may be updated to reflect that choice, and pass savings on to the user 202. The pricing information 206A, 206B with any discounting may be displayed simultaneously with the customized products 204A, 204B.

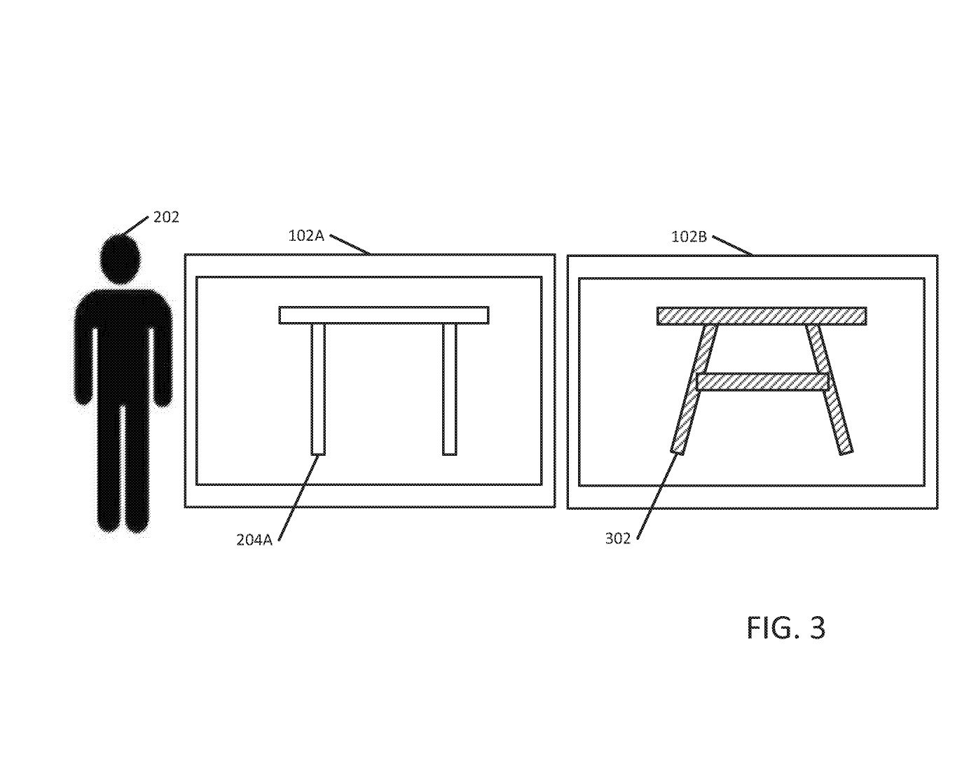

FIG. 3 is a diagram illustrating a virtual display system in a retail space according to another embodiment. Two client devices 102A, 102B display a customized product 204 and a different product 302 to a user 202. The two client devices 102A, 102B present the customized product 204 and the different product 302 on the two client devices 102A, 102B respective touchscreens. The two client devices 102A, 102B may be placed adjacent to one another and configured to logically operate as one client device. The logical connection of the two client devices 102A, 102B allow the largest products to be displayed simultaneously at their actual sizes for user 202 interaction and comparison. In another embodiment, the customized product 204 and the different product 302 may be displayed on one client device as the displayed products' actual size allows. The client device 102 may display product dimensions simultaneously so that the user 202 may obtain a better understanding of the displayed products in relation to one another. In one embodiment, the interactive touchscreen 108 may be larger than 120 inches to facilitate the display of larger products.

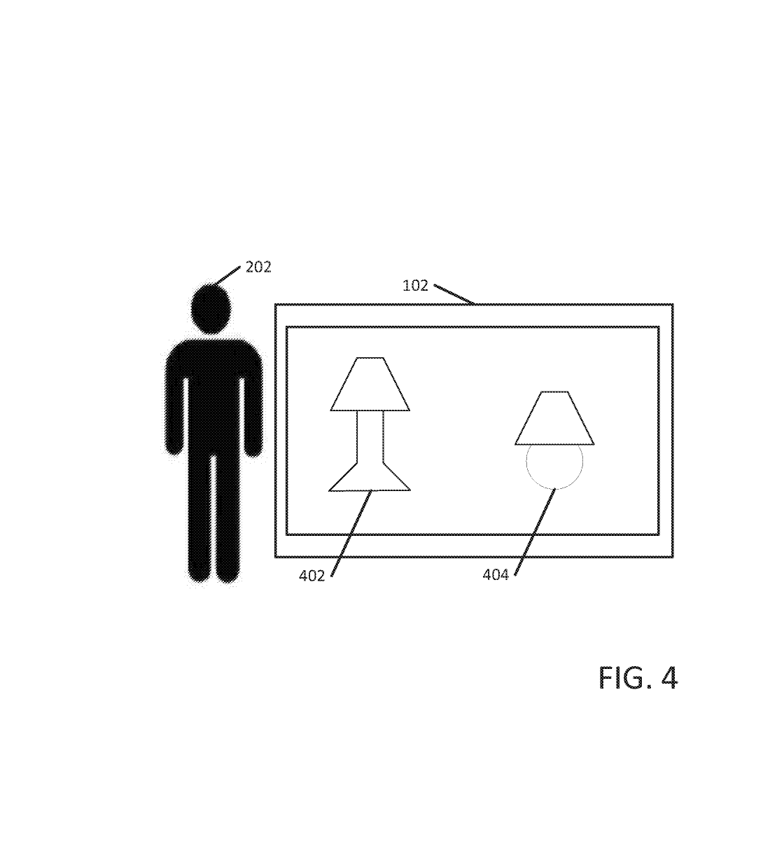

FIG. 4 is a diagram illustrating a virtual display system in a retail space according to an exemplary embodiment. The client device 102 displays two related products 402, 404. The client device 102 displays the two related products 402, 404 at actual size for user 202 comparison. As the two related products are smaller, the interactive touchscreen 108 may have a diagonal measurement of 36 inches or greater. For mid-range sized products, the interactive touchscreen 108 may have a diagonal measurement of 72 inches or greater.

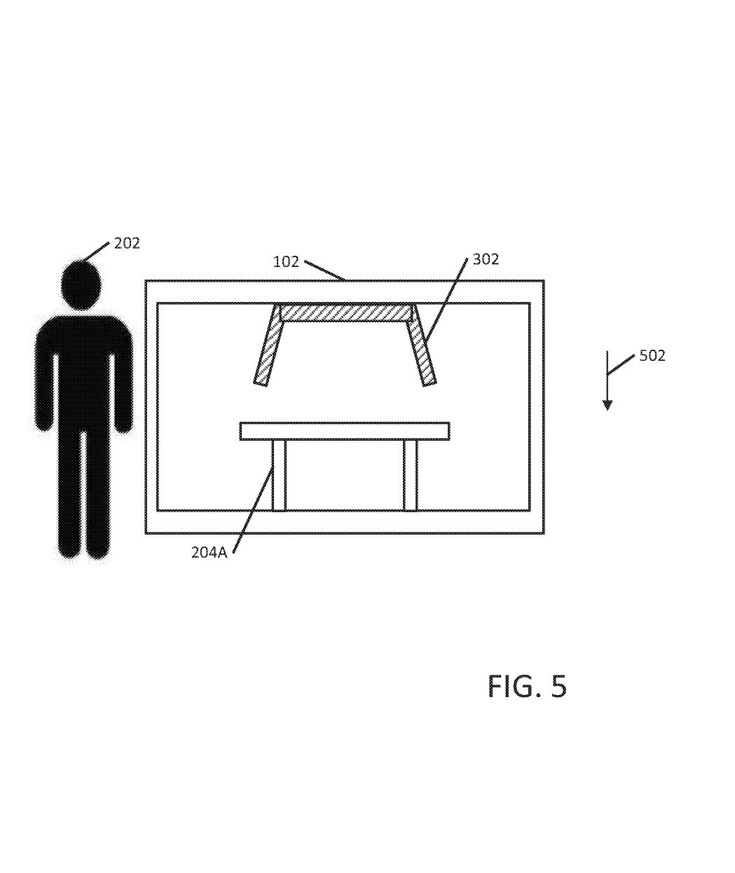

FIG. 5 is a diagram illustrating using a virtual display system in a retail space according to an exemplary embodiment. A user 202 interacts with the client device 102 using the interactive touchscreen 108. The interactive touchscreen 108 may be configured to receive input in the form of touch or gesture. Touch based input may take the form of a tap, or double tap to select. Gesture based input may take the form of a finger swipe, multi-finger pinch, or multi-finger turn. A customized product 204A may be navigated to and away from utilizing the touch or gesture based input. The user 202 provides a gesture based input to the interactive touchscreen 108 in the form of a swipe of the finger in the downward direction 502. The client device 102 can move the image of the customized product 204A in the downward direction 502 out of view. The client device simultaneously moves the different product 302 in the downward direction 502 and into the view of the user 202 on the interactive touchscreen 108.

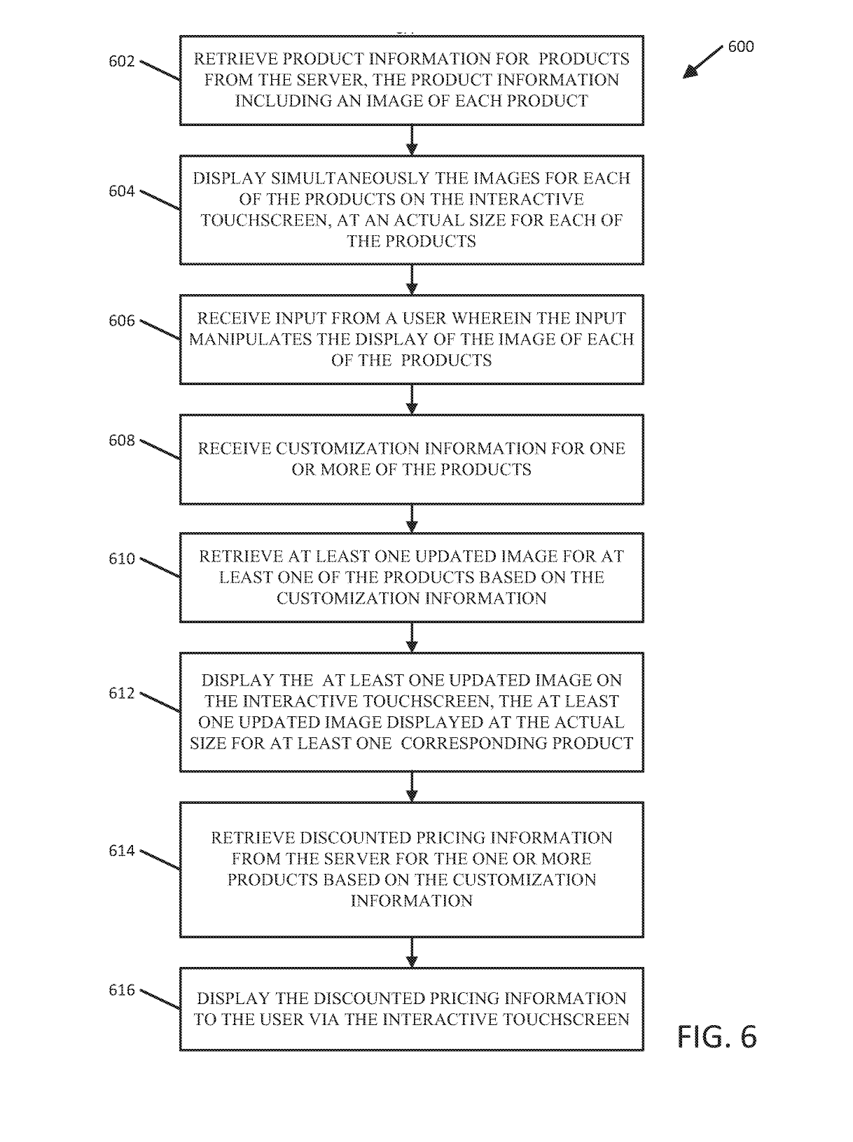

FIG. 6 is a block diagram illustrating a process for presenting products using a virtual display system in a retail space according to an exemplary embodiment.

At step 602, the product retrieval module 106 retrieves product information for two or more products from the server 104, where the product information includes an image of the product. The server 104 may retrieve the product information from the databases 110A, 110B. The product information may additionally include product dimensions, pricing information, and descriptions. Alternatively, the server 104 may retrieve customization information from third party server 114 via the network 112 for the product represented as an image. The third party server 114 may be controlled by the manufacturer of the product, or may be controlled by a distributor of the product. The third party server 114 may provide customization information based on the respective materials required for the customization. The third party server 114 may provide discounts to pricing information based on the materials available. The third party server 114 may provide updated shipping dates for the product if customization options introduce delay in the production of the product. The product information may include parameterization which allows for the identification and replacement of graphical elements affected by customization selections.

At step 604, the product retrieval module 106 displays simultaneously the images for two or more products on the interactive touchscreen 108, where the images simultaneously display at an actual size. The display may include pricing information, as well as customization information in a format that the user may select. Additionally, the images may include shipping options available for the products.

At step 606, the interactive touchscreen 108 receives input from a user where the input manipulates the display of the image for each of the product images displayed. The user 202 may utilize the interactive touchscreen 108 to index through a product catalog. Alternatively the user may use the interactive touchscreen 108 to change the view of the product image. The input may also correspond to a selection of a customization option, the selection of a delivery option, and the selection of an option to purchase.

At step 608, the product retrieval module 106 receives input through the interactive touchscreen 108 from a user where the input may be customization information for the product. The user 202 may utilize the interactive touchscreen 108 to select one or many of customization options 208A, 208B. The client device 102 may transmit the selected customization option 208A, 208B to the server 104. The server 104 may verify with the third party server 112 that the selected customization option 208A, 208B remains an available customization option.

At step 610, the product retrieval module 106 retrieves an updated image for the product based on customization information. The server 104, based on the selected optimization option 208A, 208B, may generate a new image of the product reflective of the customization option selected. The image may also include an indication demonstrating which customization option was selected out of all the customization options 208A, 208B. In the case that the product information is parameterized, the image may be updated by passing the customization information as a parameter. The server 104 may apply the customization information to an image based on the passed parameters to update the image to be displayed.

At step 612, the product retrieval module 106 displays via the interactive touchscreen 108 the updated image at actual size. The server 104 transmits the updated product information containing an updated image to the client device 102. The client device 102 then refreshes the image with the updated image on the interactive touchscreen 108. The customization options 208A, 208B may be updated to reflect any selections made by the user 202 as input.

At step 614, the product retrieval module 106 retrieves pricing information from the server for the product based on any customization where pricing information is based on the customization. The server 104 retrieves updated pricing information from the databases 110A, 110B. For example, a distributor may have an excess supply of certain fabric used to customize chairs and may be willing to sell chairs with that fabric at a price lower than a chair with a more popular fabric. Such price discounting information can be transmitted along with the updated image. Additionally, the server 104 retrieves any discounting information from the third party server 114 based on the customization. Shipping discounts may be applied if the customization affects distance and the means of shipping. The server 104 transmits the pricing and discounting information to the client device 102.

At step 616, the product retrieval module 106 displays the discounted pricing information to the user through the interactive touchscreen 108. The client device 102 receives the discounted pricing information from the server 104. The client device 102 may then present the product price augmented by any discounting based on customization. The discounted pricing information in a tabular or other format to aid the user 202 in discerning product price from any discounting. Additionally shipping discounts may be displayed if the customization affects distance and means of shipping. The client device 102 through the interactive touchscreen 108 may accept input from the user 202 indicating an order of any product displayed on the interactive touchscreen. The input may include a selection of a method of delivery. Upon the receipt of input, the client device 102 may transmit an order of the product to a fulfillment center based on the selected method of delivery. The fulfillment center may be warehouse, a distribution center, or a manufacturer based on the level of customization, distance for delivery, and inventory on hand.

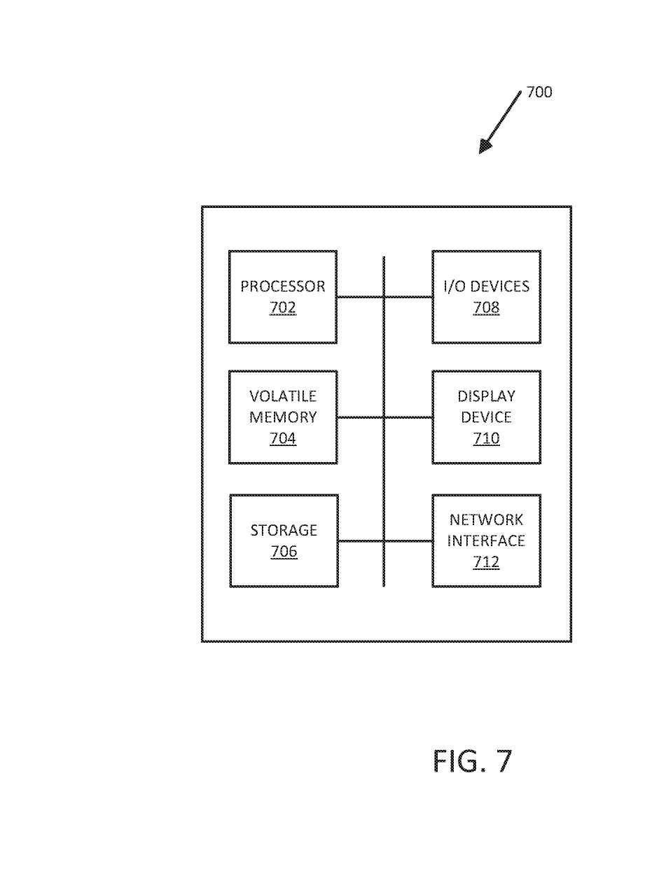

FIG. 7 is a block diagram illustrating an exemplary computing device suitable for use in an exemplary embodiment. Computing device 700 may support the execution of a product retrieval module on a client device 102 or the described functionality of server 104 or third party server 114. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, volatile memory 704 included in the computing device 700 may store computer-readable and computer-executable instructions or software (e.g., product retrieval module) for implementing exemplary operations of the computing device 700. The computing device 700 also includes configurable and/or programmable processor 702 for executing computer-readable and computer-executable instructions or software stored in the volatile memory 704 and other programs for implementing exemplary embodiments of the present disclosure. Processor 702 may be a single core processor or multiple core processor. Processor 702 may be configured to execute one or more of the instructions described in connection with computing device 700.

Volatile memory 704 may include a computer system memory or random access memory, such as DRAM, SRAM, EDO RAM, and the like. Volatile memory 704 may include other types of memory as well, or combinations thereof.

A user may interact with the computing device 700 through a display 710, such as a computer monitor or interactive touchscreen 108, which may display one or more graphical user interfaces supplemented by I/O devices 708, which may include a multi touch interface, a pointing device, an image capturing device and an reader. Additionally, I/O devices 708 may include an item scanner 714, a location-based sensor 716, a weight sensor 718, and an optical sensor 720. The item scanner 714 may take the form of UPC bar code scanners or Quick Response (QR) code readers. The location-based sensor 716 may be a sensor capable of receiving Global Positioning Satellite (GPS) system signals. Alternatively, the location-based sensor 716 may be capable of receiving multiple signals and triangulate a relative position based on observed differences in the signals. A weight sensor 718 may be among the attached I/O devices 708. The weight sensor may take the form of a scale used for the detection of items placed in the collector. An optical sensor 720 may also be attached among the I/O devices 708. The optical sensor may be a charged-coupled device (CCD) imaging sensor, an active-pixel sensor (APS), or an equivalent. Image processing hardware or software may be inclusive to the optical sensor 720, or alternatively, image processing software may execute on the host processor 702. The optical sensor 720 assists the autonomous vehicle in obstacle detection and navigation.

The computing device 700 may also include storage 706, such as a hard-drive, CD-ROM, or other computer readable media, for storing data and computer-readable instructions and/or software that implement exemplary embodiments of the present disclosure (e.g., applications). For example, storage 706 may include product information and images, input selections, and pricing information.

The computing device 700 can include a network interface 712 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 712 may include one or more antennas to facilitate wireless communication between the computing device 700 and a network and/or between the computing device 700 and other computing devices. The network interface 712 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for the virtual display of customized products in a facility comprising:
a client device equipped with an interactive touchscreen and located in the facility;
a server containing product information and communicatively coupled to the client device;
a product retrieval module configured to execute on the client device, the product retrieval module when executed:
retrieving product information for a plurality of products from the server, the product information including an image of each product;
displaying simultaneously the images for each of the plurality of products on the interactive touchscreen, wherein the images simultaneously display at an actual size for each of the plurality of products;
receiving input from a user wherein the input comprises manipulation information for the display of the image of each of the plurality of products;
receiving input from a user wherein the input comprises customization information for one or more of the plurality of products;
retrieving at least one updated image for at least one of the plurality of products based on the customization information;
displaying the at least one updated image on the interactive touchscreen, the at least one updated image displayed at the actual size for a corresponding at least one of the plurality of products;
retrieving pricing information from the server for the one or more of the plurality of products based on the customization information, wherein the pricing information is discounted based at least in part on the customization information; and
displaying the discounted pricing information to the user via the interactive touchscreen.

2. The system of claim 1 wherein the product retrieval module when executed further:
receives input from the user indicating an order of the one or more of the plurality of products and a method of delivery following the display of the discounted pricing information; and
transmits an order to a fulfillment center based on the method of delivery.

3. The system of claim 1 wherein the interactive touchscreen has a diagonal measurement of 36 inches or greater.

4. The system of claim 1 wherein the interactive touchscreen has a diagonal measurement of 72 inches or greater.

5. The system of claim 1 wherein the interactive touchscreen has a diagonal measurement of 120 inches or greater.

6. The system of claim 2 wherein the fulfillment center is a warehouse, a distribution center, or a manufacturer of the plurality of products.

7. The system of claim 1, wherein the discounting comprises reductions in pricing information based at least in part on a set of materials in the customization information.

8. The system of claim 1, wherein the product information includes information related to pricing, specifications, sizes, availability, and color selections.

9. A method for the virtual display of customized products in a facility comprising:
retrieving product information for a plurality of products from a server, the product information including an image of each product;
displaying simultaneously the images for each of the plurality of products on an interactive touchscreen coupled to the server, wherein the image simultaneously displays at an actual size for each of the plurality of products;
receiving input from a user wherein the input comprises manipulation information for the display of the image of each of the plurality of products;
receiving input from a user wherein the input comprises customization information for one or more of the plurality of products;
retrieving at least one updated image for at least one of the plurality of products based on the customization information;
displaying the at least one updated image on the interactive touchscreen, the at least one updated image displayed at the actual size for a corresponding at least one of the plurality of products;
retrieving pricing information from the server for the one or more of the plurality of products based on the customization information, wherein the pricing information is discounted based at least in part on the customization information; and
displaying the discounted pricing information to the user via the interactive touchscreen.

10. The method of claim 9, further comprising:
receives input from the user indicating an order of the one or more of the plurality of products and a method of delivery following the display of the discounted pricing information; and
transmits an order to a fulfillment center based on the method of delivery.

11. The method of claim 9, wherein the interactive touchscreen has a diagonal measurement of 36 inches or greater.

12. The method of claim 9, wherein the interactive touchscreen has a diagonal measurement of 72 inches or greater.

13. The method of claim 9, wherein the interactive touchscreen has a diagonal measurement of 120 inches or greater.

14. The method of claim 10 wherein the fulfillment center is a warehouse, a distribution center, or a manufacturer of the plurality of products.

15. The system of claim 9, wherein the discounting comprises reductions in pricing information based at least in part on a set of materials in the customization information.

16. The method of claim 9, wherein the product information comprises pricing, images, renderings, specifications, sizes, availability, and color selections.

17. A non-transitory machine-readable medium storing instructions executable by a processing device, wherein execution of the instruction causes the processing device to implement a method for the virtual display of customized products in a facility comprising:
retrieving product information for a plurality of products from a server, the product information including an image of each product;
displaying simultaneously the image for each of the plurality of products on an interactive touchscreen coupled to the server, wherein the images simultaneously display at an actual size for each of the plurality of products;
receiving input from a user wherein the input comprises manipulation information for the display of the image of each of the plurality of products;
receiving input from a user wherein the input comprises customization information for one or more of the plurality of products;
retrieving at least one updated image for at least one of the plurality of products based on the customization information;
displaying the at least one updated image on the interactive touchscreen, the at least one updated image displayed at the actual size for a corresponding at least one of the plurality of products;
retrieving pricing information from the server for the one or more of the plurality of products based on the customization information, wherein the pricing information is discounted based at least in part on the customization information; and
displaying the discounted pricing information to the user via the interactive touchscreen.

18. The non-transitory machine-readable medium of claim 16, the instructions further comprising
receiving input from the user indicating an order of the one or more of the plurality of products and a method of delivery following the display of the discounted pricing information; and
transmitting an order to a fulfillment center based on the method of delivery.

19. The non-transitory machine-readable medium of claim 16, wherein the fulfillment center is a warehouse, a distribution center, or a manufacturer of the plurality of products.

20. The non-transitory machine-readable medium of claim 16, wherein the discounting comprises reductions in pricing information based at least in part on a set of materials in the customization information.
